(19) United States
(12) Patent Application Publication
(10) Pub. No.: US 2011/0194504 A1
(43) Pub. Date: Aug. 11, 2011

(54) METHOD AND APPARATUS FOR SUPPORTING SINGLE-USER MULTIPLE-INPUT MULTIPLE-OUTPUT (SU-MIMO) AND MULTI-USER MIMO (MU-MIMO)

(75) Inventors: Alexei Yurievitch Gorokhov, San Diego, CA (US); Juan Montojo, San Diego, CA (US); Wanshi Chen, San Diego, CA (US)

(73) Assignee: QUALCOMM INCORPORATED, San Diego, CA (US)

(21) Appl. No.: 12/854,431

(22) Filed: Aug. 11, 2010

Related U.S. Application Data
(60) Provisional application No. 61/233,333, filed on Aug. 12, 2009.

(51) Int. Cl. H04B 7/02; H04L 27/00; H04B 17/00; H04W 72/04

(52) U.S. Cl. 370/329; 375/299; 375/267; 375/224

(57) ABSTRACT

Techniques for supporting data transmission with single-user multiple-input multiple-output (SU-MIMO) and multi-user MIMO (MU-MIMO) are described. A base station may transmit multiple data streams on a given time-frequency resource to a single user equipment (UE) for SU-MIMO or to multiple UEs for MU-MIMO. In an aspect, an antenna port assignment for a UE for MU-MIMO may be conveyed by reusing one or more fields of a downlink control information (DCI) format. In another aspect, a hierarchical two-tier structure may be used to convey an antenna port assignment for a UE for MU-MIMO. In yet another aspect, a UE may be configured via higher layer to report only channel quality indicator (CQI), or both CQI and precoding matrix indicator (PMI), when operating in a transmission mode supporting SU-MIMO and MU-MIMO. In yet another aspect, a UE may report CQI such that SU-MIMO and MU-MIMO can be supported for the UE.

The present application claims priority to provisional U.S. Application Ser. No. 61/233,333, entitled “SYSTEMS AND METHODS OF DUAL STREAM BEAMFORMING,” filed Aug. 12, 2009, assigned to the assignee hereof and incorporated herein by reference.

### BACKGROUND

I. Field

The present disclosure relates generally to communication, and more specifically to techniques for supporting data transmission in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. It may be desirable to efficiently support data transmission on the downlink from a base station to one or more UEs.

### SUMMARY

Techniques for supporting data transmission with single-user multiple-input multiple-output (SU-MIMO) and multi-user MIMO (MU-MIMO) are described herein. For SU-MIMO, a base station may transmit multiple data streams to a single UE on a given time-frequency resource. For MU-MIMO, the base station may transmit multiple data streams to multiple UEs on the same time-frequency resource, one or more data streams for each UE. SU-MIMO and MU-MIMO may be supported in various manners.

In an aspect, control information (e.g., an antenna port assignment) for MU-MIMO may be sent to a UE by reusing one or more fields of a downlink control information (DCI) format. In one design, the UE may be scheduled for data transmission based on a transmission mode supporting MU-MIMO. The UE may be assigned an antenna port among a plurality of antenna ports. A control message may be generated for the UE based on a DCI format available for the transmission mode. A designated field of the control message may be set to convey the antenna port assigned to the UE. The designated field may convey other information (e.g., an indication of an assignment of localized or distributed virtual resource blocks) when the DCI format is used for another transmission mode not supporting MU-MIMO.

In another aspect, a hierarchical two-tier structure may be used to convey an antenna port assignment for a UE. In one design, the UE may be configured (e.g., via Layer 3) with a plurality of antenna port combinations, which may be a subset of all possible antenna port combinations. Each antenna port combination may be associated with at least one antenna to use for data transmission among a plurality of available antenna ports. The UE may be assigned an antenna port combination among the plurality of antenna port combinations for a given data transmission. Control information may be sent (e.g., via Layer 2) to convey the antenna port combination assigned to the UE. Data may be transmitted to the UE via the antenna port combination assigned to the UE.

In yet another aspect, a UE may be configured via higher layer to report only channel quality indicator (CQI), or both CQI and precoding matrix indicator (PMI), when operating in a transmission mode supporting SU-MIMO and MU-MIMO. In one design, the UE may be configured (e.g., semi-statically via Layer 3) to report CQI and to either report PMI or not report PMI when operating in this transmission mode. The UE may send CQI and may also send PMI if it is configured to be reported by the UE. Data may be transmitted to the UE based on the CQI and also the PMI if reported by the UE.

In yet another aspect, a UE may report CQI such that SU-MIMO and MU-MIMO can be supported for the UE. In one design, the UE may send (i) first CQI determined by the UE for SU-MIMO and (ii) second CQI determined by the UE for MU-MIMO. The UE may be scheduled for data transmission with SU-MIMO or MU-MIMO. Data may be transmitted to the UE based on (i) the first CQI if the UE is scheduled with SU-MIMO or (ii) the second CQI if the UE is scheduled with MU-MIMO. In one design, the second CQI may comprise one or more differential CQI values for one or more data streams or layers. Each differential CQI value may be determined based on the first CQI as a reference.

Various aspects and features of the disclosure are described in further detail below.

### BRIEF DESCRIPTION OF THE DRAWINGS

FIG. 1 shows a wireless communication network.

FIG. 2 shows data transmission from a base station to one or more UEs.

FIGS. 3 and 4 show a process and an apparatus, respectively, for conveying an antenna port assignment by reusing a field of a DCI format.

FIGS. 5 and 6 show a process and an apparatus, respectively, for receiving an antenna port assignment conveyed by reusing a field of a DCI format.

FIGS. 7 and 8 show a process and an apparatus, respectively, for conveying an antenna port assignment using a two-tier structure.

FIGS. 9 and 10 show a process and an apparatus, respectively, for receiving an antenna port assignment conveyed using a two-tier structure.

FIGS. 11 and 12 show a process and an apparatus, respectively, for configuring PMI reporting by a UE.

FIGS. 13 and 14 show a process and an apparatus, respectively, for reporting PMI by a UE.

FIGS. 15 and 16 show a process and an apparatus, respectively, for receiving CQI for SU-MIMO and MU-MIMO.

FIGS. 17 and 18 show a process and an apparatus, respectively, for reporting CQI for SU-MIMO and MU-MIMO.

FIG. 19 shows a block diagram of a base station and a UE.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

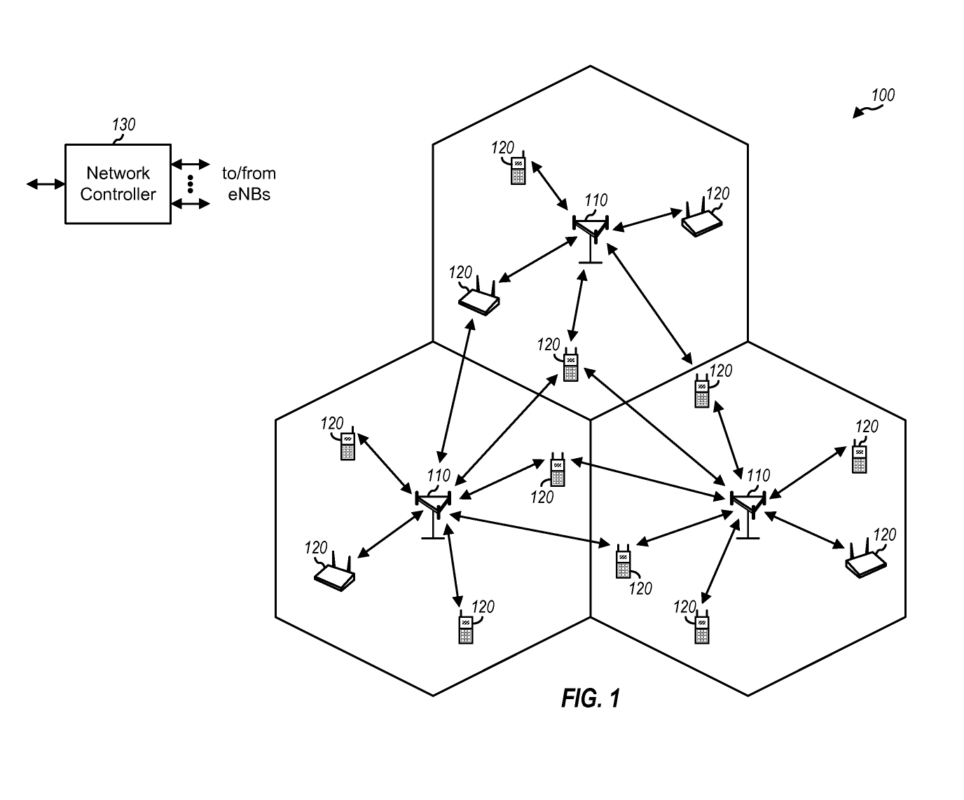

FIG. 1 shows a wireless communication network 100, which may be an LTE network or some other wireless network. Wireless network 100 may include a number of evolved Node Bs (eNBs) 110 and other network entities. An eNB may be an entity that communicates with the UEs and may also be referred to as a base station, a Node B, an access point, etc. Each eNB 110 may provide communication coverage for a particular geographic area and may support communication for the UEs located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area. The terms “eNB” and “cell” are used interchangeably herein.

A network controller 130 may couple to a set of eNBs and may provide coordination and control for these eNBs. Network controller 130 may comprise a Mobile Management Entity (MME) and/or some other network entity.

UEs may be dispersed throughout the wireless network, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc.

The wireless network 100 may support a number of transmission modes. Each transmission mode may be associated with the following:
A particular transmission scheme for a physical downlink shared channel (PDSCH) used to send data,
A pair of DCI formats that can be used to send control information on a physical downlink control channel (PDCCH), and
Other features.

For example, LTE Release 9 (Rel-9) supports eight transmission modes 1 through 8. Transmission mode 7 supports (i) beamforming for one stream when DCI format 1 is used or (ii) transmit diversity when DCI format 1A is used, when the PDCCH cyclic redundancy check (CRC) is scrambled by a UE-specific identity (ID) (or C-RNTI). Transmission mode 8 supports (i) beamforming for two streams (or dual-stream beamforming) when a first DCI format is used or (ii) transmit diversity when a second DCI format is used. Beamforming is a process to control the spatial direction of a transmission toward a target receiver and/or away from an unintended receiver. Beamforming may be performed by applying a precoding vector to the transmission at a transmitter. The various transmission modes in LTE are described 3GPP TS 36.211, entitled “Evolved Universal Terrestrial Radio Access (E-UTRA); Physical Channels and Modulation,” which is publicly available.

Transmission mode 8 may be used to support SU-MIMO and MU-MIMO. For SU-MIMO, an eNB/cell may transmit multiple (S) data streams to a single UE on a given time-frequency resource, where S>1 in general and S=2 in LTE Rel-9. For MU-MIMO, the eNB may transmit multiple data streams to multiple UEs on the same time-frequency resource, one or more data streams for each UE. When S=2 as in LTE Rel-9, transmission mode 8 may be used to support dual-stream beamforming (DS-BF) for one UE with SU-MIMO or for two UEs with MU-MIMO.

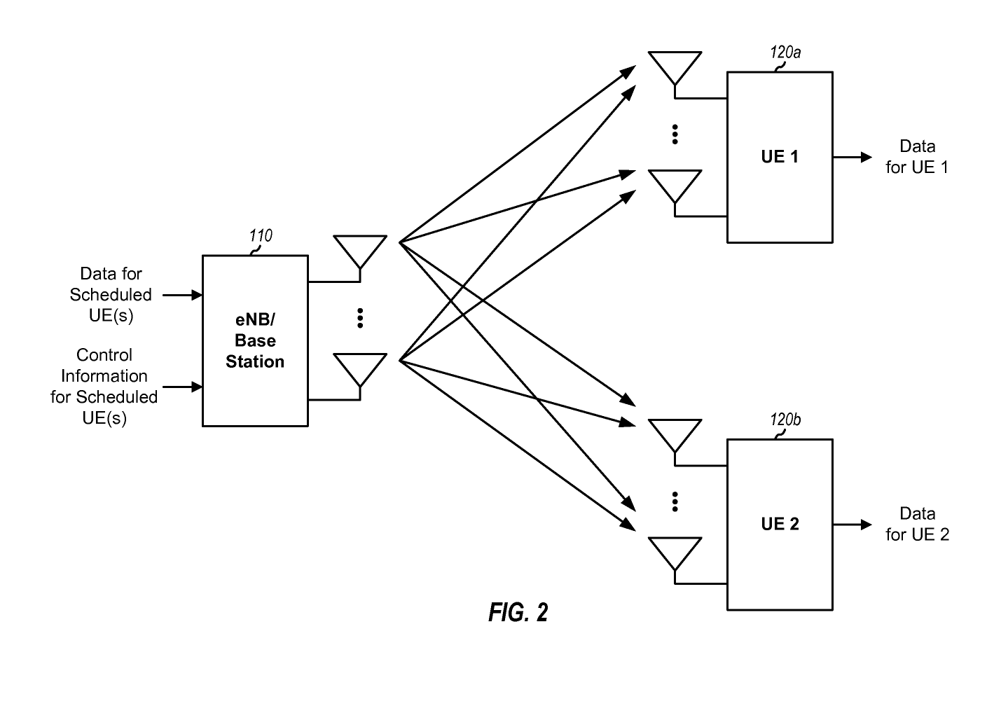

FIG. 2 shows data transmission from an eNB to one or more UEs on a given time-frequency resource. The eNB may be equipped with multiple antennas. For SU-MIMO, the eNB may transmit multiple data streams to a single UE equipped with multiple antennas. For MU-MIMO, eNB cell may transmit multiple data streams to multiple UEs, and each UE may be equipped with one or more antennas.

For SU-MIMO and MU-MIMO, the eNB may or may not precode data prior to transmission and may transmit each data stream from a different antenna port. Each antenna port may correspond to a physical antenna if precoding is not performed or a virtual antenna if precoding is performed. The eNB may also transmit a UE-specific reference signal (UE-RS) from each antenna port on which a data stream is transmitted. A reference signal is a signal that is known a priori by a transmitter and a receiver and may also be referred to as pilot. A UE-RS is a reference signal that is specific for a UE, e.g., generated with or without precoding in the same manner as a data stream transmitted to the UE.

In general, S antenna ports may be defined to support transmission of S data streams in transmission mode 8 for SU-MIMO or MU-MIMO. S different UE-RS may be transmitted from the S antenna ports, one UE-RS for each data stream. A UE may be able to receive and demodulate a data stream transmitted to that UE based on the associated UE-RS and would not need to be aware of the precoding, if any, performed by the eNB on the data stream. In general, S may be any suitable value, and the S antenna ports may be given any designation. In LTE Rel-9, S=2, and antenna ports 7 and 8 are used for transmission mode 8.

A set of DCI formats may be supported to send control information to UEs on the PDCCH. Each DCI format may include a set of fields that carry various types of control information for a UE. The various DCI formats in LTE are described in 3GPP TS 36.212, entitled “Evolved Universal Terrestrial Radio Access (E-UTRA); Multiplexing and channel coding,” which is publicly available.

In LTE, a UE may be semi-statically configured with one of the supported transmission modes. For downlink unicast transmission on the PDSCH, the UE may decode the PDCCH based on two different DCI formats—DCI format 1A and one other DCI format that may be dependent on the configured transmission mode. There are up to 22 decoding candidates for the PDCCH, with up to 6 decoding candidates from a common search space and up to 16 decoding candidates from a UE-specific search space. The UE may perform 44 PDCCH blind decodes for two different DCI sizes for each of the 22 decoding candidates. Multiple DCI formats may have the same DCI size.

In an aspect, control information (e.g., an antenna port assignment) for MU-MIMO may be sent to a UE by reusing one or more fields of a DCI format. In one design, DCI format 1A defined in LTE Rel-8 may be used to support MU-MIMO defined in LTE Rel-9.

In LTE Rel-8, DCI format 1A includes the following fields:
Flag to differentiate between DCI format 0 or 1A,
Flag to indicate assignment of localized virtual resource blocks (LVRBs) or distributed virtual resource blocks (DVRBs),
Resource block assignment,
Modulation and coding scheme,
HARQ process number,
New data indicator,
Redundancy version,
Transmit power control command for physical uplink control channel (PUCCH), and
Downlink assignment index (for time division duplexing (TDD) only).

In one design, the LVRB/DVRB flag in DCI format 1A may be reused to convey an antenna port assigned to a UE for MU-MIMO in transmission mode 8. Dual-stream beamforming (DS-BF) may be used in transmission mode 8 to transmit two data streams from two antenna ports to two UEs. Each UE may be assigned one of the two antenna ports. In one design, a control message in DCI format 1A may be sent to each UE, and the LVRB/DVRB flag in the control message may be used to indicate which antenna port is assigned to that UE. In one design, the LVRB/DVRB flag may be set to (i) a first value (e.g., ‘0’) to indicate that a UE is assigned a first antenna port (e.g., antenna port 7) or (ii) a second value (e.g., ‘1’) to indicate that the UE is assigned a second antenna port (e.g., antenna port 8). In another design, another field in DCI format 1A may be used to convey an antenna port assigned to a UE for MU-MIMO. DCI format 1A may be referred to as a compact DCI format or DCI format 1E when used to send control information for a UE in MU-MIMO.

In another design, another DCI format defined in LTE Rel-8 may be used to support MU-MIMO defined in LTE Rel-9. A field in this DCI format may be reused to convey an antenna port assigned to a UE for MU-MIMO. This field may be any suitable field that is not pertinent (or is less pertinent) for MU-MIMO.

In general, S antenna ports may be supported for MU-MIMO. If a UE can be assigned one of the S antenna ports for MU-MIMO, then B=┌log₂(S)┐ may be used to convey the assigned antenna port, where “┌ ┐” denotes a ceiling operator. For example, if S=8 antenna ports are supported, then B=3 bits may be used to convey the assigned antenna port.

In another design, a bitmap of S bits may be used to convey one or more antenna ports assigned to a UE for MU-MIMO. The bitmap may include one bit for each available antenna port. Each bit in the bitmap may be set to (i) a first value (e.g., ‘0’) to indicate that the corresponding antenna port is not assigned to a UE or (ii) a second value (e.g., ‘1’) to indicate that the corresponding antenna port is assigned to the UE.

Other information may also be sent in a control message to support MU-MIMO. For example, the control message may include one or more of the following:
Indication of whether the UE is scheduled with SU-MIMO or MU-MIMO,
Indication of a UE-RS pattern used for the UE for rank 1 transmission, and
Indication of a transmission scheme (e.g., beamforming, transmit diversity, large delay cyclic delay diversity (CDD), etc.) for the PDSCH used to send data to the UE.

In another aspect, a hierarchical two-tier structure may be used to convey an antenna port assignment for a UE. In one design, the UE may be configured with a subset of all possible antenna port combinations (e.g., via Layer 3). For example, the UE may be configured with N antenna port combinations out of M possible antenna port combinations, where N<M. Each antenna port combination may be associated with one or more antenna ports to use for data transmission. Thereafter, the UE may be dynamically assigned one of the N configured antenna port combinations (e.g., via Layer 2 control information sent on the PDCCH). The number of bits used to convey the assigned antenna port combination may be reduced by configuring the UE with only a subset of the M possible antenna port combinations. As an example, S=8 antenna ports may be available, and M=255 possible antenna port combinations may be defined. One antenna port combination among the M=255 possible antenna port combinations may be assigned to the UE and may be conveyed with eight bits. Alternatively, the UE may be configured with N=16 antenna port combinations out of M=255 possible antenna port combinations. One antenna port combination among the N=16 configured antenna port combinations may be assigned to the UE and may be conveyed with four bits.

The bits used to convey the antenna port combination assigned to the UE may be taken from one or more fields of a DCI format used to send a control message to the UE. For example, the bits used to convey the assigned antenna port combination may comprise (i) one bit taken from the LVRB/DVRB flag, (ii) one or more bits realized via scrambling of a CRC, (iii) one or more bits realized by re-interpreting some reserved fields (e.g., such as a transport block to codeword swap flag and/or a new data indicator (NDI) of a disabled transport block), (iv) one bit taken from a power offset indicator, and/or (v) one or more bits taken from some other fields.

In yet another aspect, large delay CDD may be used as a fallback mode for transmission mode 8. Dual-stream beamforming may be used for transmission mode 8 in low mobility scenarios, where closed-loop beamforming operation may be more reliable. In this case, a UE may derive CQI based on a particular precoding vector and may report the CQI (with or without the precoding vector) to an eNB. The eNB may then transmit data to the UE based on the reported CQI and possibly the precoding vector if reported. In high mobility scenarios, closed-loop beamforming operation may become unreliable, and open-loop beamforming operation such as large delay CDD may be used instead. For large delay CDD, the eNB may cycle through a set of precoding vectors and may use different precoding vectors in different time intervals. This may provide time and spatial diversity.

The eNB may switch from dual-stream beamforming to large delay CDD (instead of transmit diversity) in transmission mode 8 (e.g., when warranted by channel conditions and/or other factors). In one design, the eNB may inform the UE of the switch to large delay CDD (e.g., by using a different DCI format to send a control message to the UE). In another design, the eNB may not inform the UE of the switch to large delay CDD.

In yet another aspect, a UE may be configured via higher layer (e.g., Layer 3) to report (i) only CQI or (ii) a combination of CQI and PMI and/or rank indicator (RI), when the UE is operating in a transmission mode supporting SU-MIMO and MU-MIMO. RI may indicate a rank for data transmission to the UE. The rank may correspond to the number of data streams that can be sent to the UE or the number of layers that can be used to transmit data for the UE. PMI may indicate a precoding vector (if rank=1) or a precoding matrix (if rank>1) to use to precode data prior to transmission to the UE.

In one design, the UE may be configured to report or not report PMI and to report or not report RI. In this design, PMI and RI may be treated separately, and the UE may be separately configured for PMI reporting and RI reporting. In another design, the UE may be configured to report or not report both PMI and RI. In this design, PMI and RI may be paired, and the UE may be configured to report both PMI and RI, or neither. In one design, if RI is not reported, then a rank of one may be assumed. If RI is reported, then the rank may have a value of one or greater.

It may not be necessary to report PMI and RI in certain scenarios. For example, when transmit diversity or large delay CDD is used in transmission mode 8, precoding (if any) may be performed by an eNB without any input from the UE. In this case, the UE may be configured via higher layer to only report CQI, and not PMI or RI. Even when beamforming is used in transmission mode 8, PMI and RI may or may not be reported, depending on how beamforming is performed. For closed loop beamforming, the UE may be configured to report PMI, RI, and CQI, and the eNB may use the reported PMI to precode data prior to transmission to the UE. If TDD is employed, then the same frequency spectrum may be used for both the downlink and uplink. For TDD, the eNB may assume channel reciprocity between the downlink and uplink and may be able to determine PMI and RI for the downlink based on a reference signal transmitted by the UE on the uplink. In this case, the UE may skip reporting PMI and RI and may report only CQI.

In yet another aspect, a UE may report CQI such that SU-MIMO and MU-MIMO can be supported for the UE. The UE may be scheduled with SU-MIMO or MU-MIMO in any given scheduling period. The UE may determine the received signal quality of each data stream that can be transmitted to the UE. The received signal quality of each data stream may be dependent on whether the UE is scheduled with SU-MIMO or MU-MIMO. The difference in the received signal quality of a given data stream may be due to (i) different precoding vectors being used for the data stream for SU-MIMO and MU-MIMO, (ii) different interference being observed by the data stream for SU-MIMO and MU-MIMO, (iii) different transmit power levels being used for SU-MIMO and MU-MIMO, and/or (iv) other factors that may be different for SU-MIMO and MU-MIMO. In any case, CQI for SU-MIMO may be different from CQI for MU-MIMO.

The UE may estimate the received signal quality of each data stream for both SU-MIMO and MU-MIMO. Received signal quality may be quantified by a signal-to-noise-and-interference ratio (SINR) or some other metric. The SINR may be different for SU-MIMO and MU-MIMO since there may be no intra-cell interference with SU-MIMO and some intra-cell interference with MU-MIMO. For SU-MIMO, the UE may evaluate different possible precoding vectors and matrices that can be used for data transmission, determine the SINR of each data stream with the best precoding vector or matrix, and map the SINR of each data stream to a corresponding CQI value. For MU-MIMO, the UE may determine the SINR of each data stream based on an assumption of certain rank (e.g., rank 1) and certain precoding vector or matrix that will be used by the eNB and may map the SINR of each data stream to a corresponding CQI value.

In one design, to support SU-MIMO, the UE may report one CQI value for rank 1 or two CQI values for rank 2. For rank 2, the UE may report (i) two absolute CQI values for two data streams or (ii) an absolute/base CQI value for the first data stream and a differential CQI value for the second data stream. An absolute CQI value may be obtained by mapping an SINR of a data stream to a CQI value based on a mapping table. A differential CQI value may be obtained by (i) determining the difference between the SINRs of two data streams and (ii) mapping this difference to a differential CQI value based on a mapping table. The UE can send an absolute CQI value with a sufficient number of bits to obtain good performance. The UE can typically send a differential CQI value with fewer bits, which may save overhead.

In one design, to support MU-MIMO, the UE may report one CQI value for rank 1 or two CQI values for rank 2. In one design, the UE may report only differential CQI values for MU-MIMO. For rank 1, the UE may report one differential CQI value determined based on the difference between the SINR of the first data stream with SU-MIMO and the SINR of the first data stream with MU-MIMO. For rank 2, the UE may report two differential CQI values for two data streams. The differential CQI value for each data stream may be determined based on the difference between the SINR of that data stream with SU-MIMO and the SINR of that data stream with MU-MIMO. In this design, the differential CQI values for MU-MIMO may be generated based on the SINRs of the data streams with SU-MIMO as reference.

In another design, the UE may report absolute and differential CQI values for MU-MIMO. For rank 1, the UE may report one absolute CQI value for one data stream, which may be determined based on the SINR of the data stream with MU-MIMO. For rank 2, the UE may report (i) two absolute CQI values for two data streams or (ii) an absolute/base CQI value for the first data stream and a differential CQI value for the second data stream. In this design, the absolute and differential CQI values for MU-MIMO may be generated based on the SINRs of the data streams with MU-MIMO.

The UE may generate various CQI reports to support SU-MIMO and MU-MIMO. For example, the UE may determine wideband CQI, subband CQI, subband differential CQI, spatial differential CQI, MU/SU differential CQI, etc. Wideband CQI may be generated for all or a large portion of the system bandwidth. Subband CQI may be generated for a particular subband, which may be specified as a function of the system bandwidth and may be approximately 1.08 MHz in LTE. Subband differential CQI may include differential CQI values for different subbands, with one subband being used as a reference. Spatial differential CQI may include differential CQI values for different data streams or layers, with one stream/layer being used as a reference. MU/SU differential CQI may include differential CQI values for data streams with MU-MIMO, with the SINRs of data streams with SU-MIMO being used as a reference, as described above. The UE may determine differential CQI values across one dimension, e.g., frequency, spatial, time, MIMO type, etc. The UE may also determine differential CQI values across multiple dimensions.

The UE may send CQI reports in various manners to support SU-MIMO and MU-MIMO. In one design of CQI reporting, the UE may send CQI reports periodically, e.g., at a rate configured for the UE. In one design, the UE may bundle and send CQI for both SU-MIMO and MU-MIMO in each CQI report. In another design, the UE may send CQI for SU-MIMO and CQI for MU-MIMO in separate CQI reports, e.g., with time division multiplexing (TDM). The UE may send the CQI reports for SU-MIMO and MU-MIMO at the same rate or different rates. In another design of CQI reporting, the UE may send CQI reports when triggered.

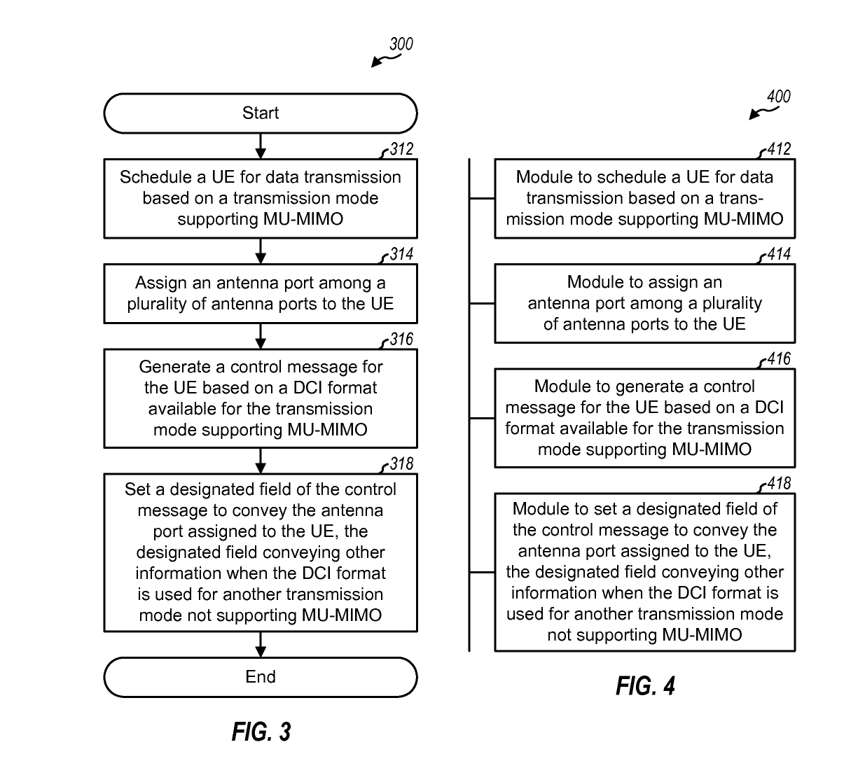

FIG. 3 shows a design of a process 300 for conveying an antenna port assignment. Process 300 may be performed by a network (e.g., a base station/eNB and/or some other network entity). A UE may be scheduled for data transmission based on a transmission mode supporting MU-MIMO (block 312). The UE may be assigned an antenna port among a plurality of antenna ports (block 314). A control message may be generated for the UE based on a DCI format available for the transmission mode supporting MU-MIMO (block 316). A designated field of the control message may be set to convey the antenna port assigned to the UE (block 318). The designated field may convey other information when the DCI format is used for another transmission mode not supporting MU-MIMO.

In one design, the plurality of antenna ports may comprise a first antenna port and a second antenna port. The designated field may be set to (i) a first value to indicate the first antenna port being assigned to the UE or (ii) a second value to indicate the second antenna port being assigned to the UE. In one design, the designated field may comprise a flag indicating an assignment of localized or distributed VRBs when the DCI format is used for another transmission mode not supporting MU-MIMO. The designated field may also be another field conveying other information.

FIG. 4 shows a design of an apparatus 400 for conveying an antenna port assignment. Apparatus 400 includes a module 412 to schedule a UE for data transmission based on a transmission mode supporting MU-MIMO, a module 414 to assign an antenna port among a plurality of antenna ports to the UE, a module 416 to generate a control message for the UE based on a DCI format available for the transmission mode supporting MU-MIMO, and a module 418 to set a designated field of the control message to convey the antenna port assigned to the UE, with the designated field conveying other information when the DCI format is used for another transmission mode not supporting MU-MIMO.

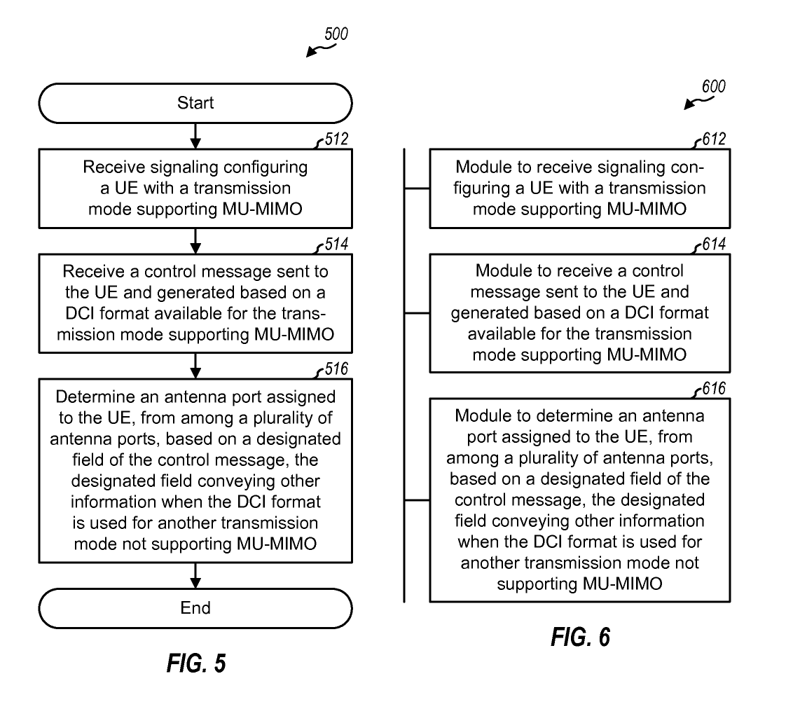

FIG. 5 shows a design of a process 500 for receiving an antenna port assignment. Process 500 may be performed by a UE (as described below) or by some other entity. The UE may receive signaling configuring the UE with a transmission mode supporting MU-MIMO (block 512). The UE may receive a control message sent to the UE and generated based on a DCI format available for the transmission mode supporting MU-MIMO (block 514). The UE may determine an antenna port assigned to the UE, from among a plurality of antenna ports, based on a designated field of the control message (block 516). The designated field may convey other information when the DCI format is used for another transmission mode not supporting MU-MIMO.

The plurality of antenna ports may comprise a first antenna port and a second antenna port. In one design, the UE may determine that the first antenna port is assigned to the UE based on the designated field being set to a first value and may determine that the second antenna port is assigned to the UE based on the designated field being set to a second value. In one design, the designated field may comprise a flag indicating an assignment of localized or distributed VRBs when the DCI format is used for another transmission mode not supporting MU-MIMO. The designated field may also be another field conveying other information.

FIG. 6 shows a design of an apparatus 600 for receiving an antenna port assignment. Apparatus 600 includes a module 612 to receive signaling configuring a UE with a transmission mode supporting MU-MIMO, a module 614 to receive a control message sent to the UE and generated based on a DCI format available for the transmission mode supporting MU-MIMO, and a module 616 to determine an antenna port assigned to the UE, from among a plurality of antenna ports, based on a designated field of the control message, with the designated field conveying other information when the DCI format is used for another transmission mode not supporting MU-MIMO.

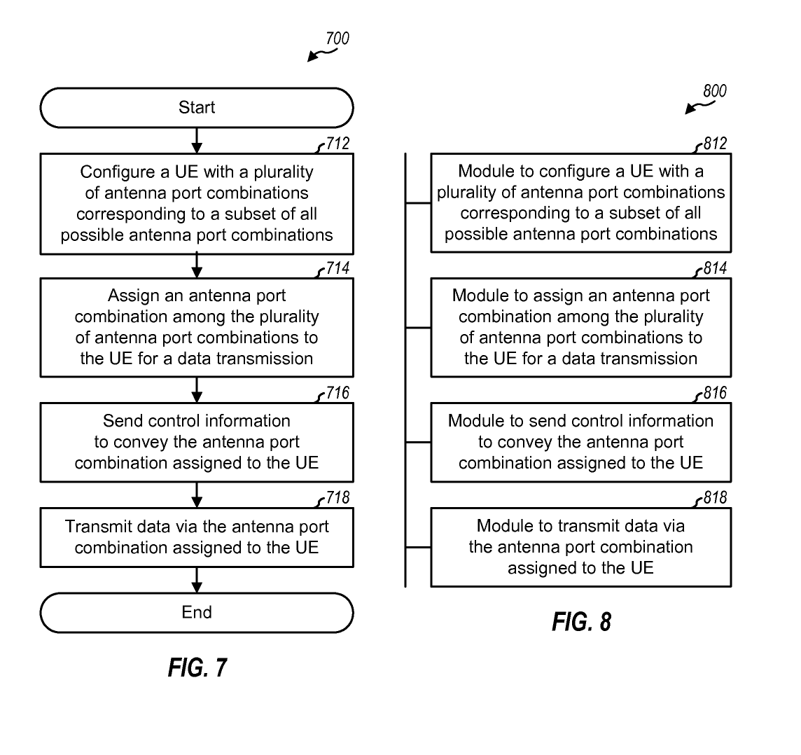

FIG. 7 shows a design of a process 700 for conveying an antenna port assignment. Process 700 may be performed by a network (e.g., a base station/eNB and/or some other network entity). A UE may be configured with a plurality of antenna port combinations corresponding to a subset of all possible antenna port combinations (block 712). In one design, each antenna port combination may be associated with at least one antenna to use for data transmission among a plurality of available antenna ports. The UE may be assigned an antenna port combination among the plurality of antenna port combinations for a data transmission (block 714). Control information may be sent to convey the antenna port combination assigned to the UE (block 716). In general, the assigned antenna port combination may be used for data transmission on the downlink or the uplink. In one design, data may be transmitted to the UE via the antenna port combination assigned to the UE (block 718).

In one design, the UE may be configured with the plurality of antenna port combinations via Layer 3, and the control information may be sent to the UE via Layer 2. In one design, the UE may be semi-statically configured with the plurality of antenna port combinations and may be dynamically assigned one antenna port combination for each data transmission.

In one design, the UE may be scheduled for data transmission based on a transmission mode supporting MU-MIMO. In one design, a control message for the UE may be generated based on a DCI format available for the transmission mode supporting MU-MIMO. At least one designated field of the control message may be used to convey the antenna port combination assigned to the UE. The at least one designated field may convey other information when the DCI format is used for another transmission mode not supporting MU-MIMO. The assigned antenna port combination may also be conveyed to the UE in other manners.

FIG. 8 shows a design of an apparatus 800 for conveying an antenna port assignment. Apparatus 800 includes a module 812 to configure a UE with a plurality of antenna port combinations corresponding to a subset of all possible antenna port combinations, a module 814 to assign an antenna port combination among the plurality of antenna port combinations to the UE for a data transmission, a module 816 to send control information to convey the antenna port combination assigned to the UE, and a module 818 to transmit data via the antenna port combination assigned to the UE.

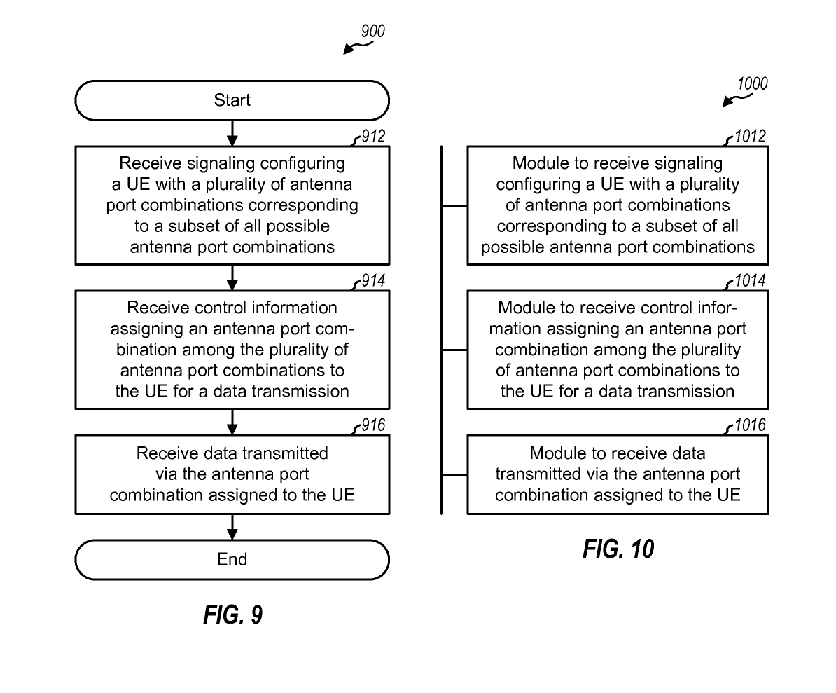

FIG. 9 shows a design of a process 900 for receiving an antenna port assignment. Process 900 may be performed by a UE (as described below) or by some other entity. The UE may receive signaling configuring the UE with a plurality of antenna port combinations corresponding to a subset of all possible antenna port combinations (block 912). The UE may receive control information assigning an antenna port combination among the plurality of antenna port combinations to the UE for a data transmission (block 914). The UE may receive data transmitted via the antenna port combination assigned to the UE (block 916).

In one design, the UE may receive the signaling configuring the UE via Layer 3 and may receive the control information assigning the antenna port combination via Layer 2. In one design, the UE may be semi-statically configured with the plurality of antenna port combinations and may be dynamically assigned one antenna port combination for each data transmission.

In one design, the UE may be scheduled for data transmission based on a transmission mode supporting MU-MIMO. The UE may receive a control message generated based on a DCI format available for the transmission mode supporting MU-MIMO. The UE may determine the antenna port combination assigned to the UE based on at least one designated field of the control message. The designated field(s) may convey other information when the DCI format is used for another transmission mode not supporting MU-MIMO. The UE may also receive the control information conveying the assigned antenna port combination in other manners.

FIG. 10 shows a design of an apparatus 1000 for receiving an antenna port assignment. Apparatus 1000 includes a module 1012 to receive signaling configuring a UE with a plurality of antenna port combinations corresponding to a subset of all possible antenna port combinations, a module 1014 to receive control information assigning an antenna port combination among the plurality of antenna port combinations to the UE for a data transmission, and a module 1016 to receive data transmitted via the antenna port combination assigned to the UE.

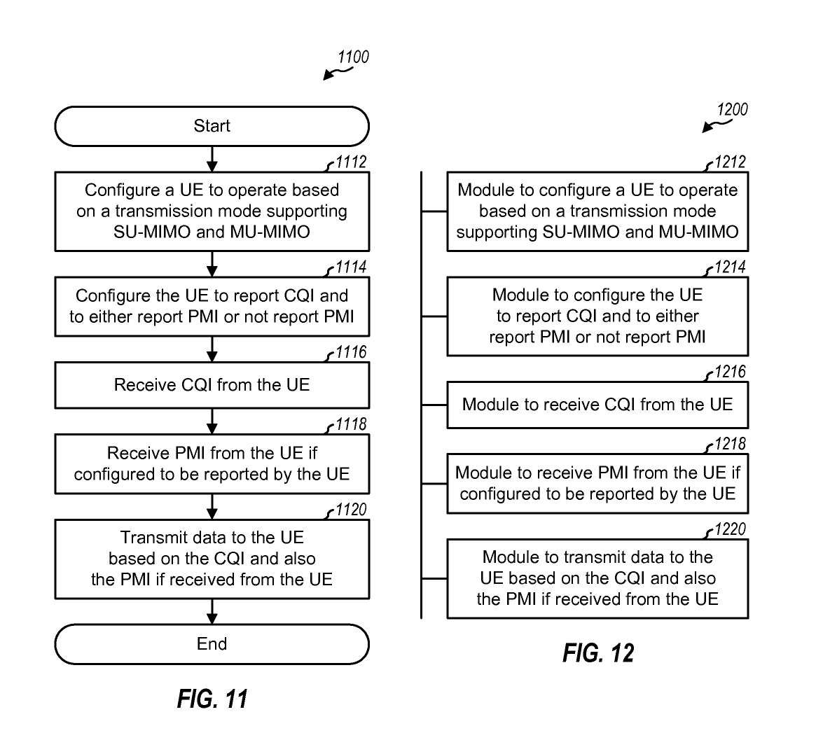

FIG. 11 shows a design of a process 1100 for configuring PMI/RI reporting. Process 1100 may be performed by a network (e.g., a base station/eNB and/or some other network entity). A UE may be configured to operate based on a transmission mode supporting SU-MIMO and MU-MIMO (block 1112). The UE may be configured (e.g., semi-statically via Layer 3) to report CQI and to either report PMI or not report PMI (block 1114). CQI may be received from the UE (block 1116). PMI may be received from the UE if it is configured to be reported by the UE (block 1118). Data may be transmitted to the UE based on the CQI and also the PMI if received from the UE (block 1120).

In one design, data may be precoded based on a precoding vector or matrix indicated by the PMI, if received from the UE. In one design, data may be transmitted with transmit diversity if PMI is not received from the UE.

In one design, the UE may be configured to either report RI or not report RI. RI may be received from the UE if it is configured to be reported by the UE. Data may be transmitted to the UE based further on the RI, if received from the UE. Data may be transmitted based on a rank of one if the UE is configured to not report RI.

FIG. 12 shows a design of an apparatus 1200 for configuring PMI/RI reporting. Apparatus 1200 includes a module 1212 to configure a UE to operate based on a transmission mode supporting SU-MIMO and MU-MIMO, a module 1214 to configure the UE to report CQI and to either report PMI or not report PMI, a module 1216 to receive CQI from the UE, a module 1218 to receive PMI from the UE if configured to be reported by the UE, and a module 1220 to transmit data to the UE based on the CQI and also the PMI if received from the UE.

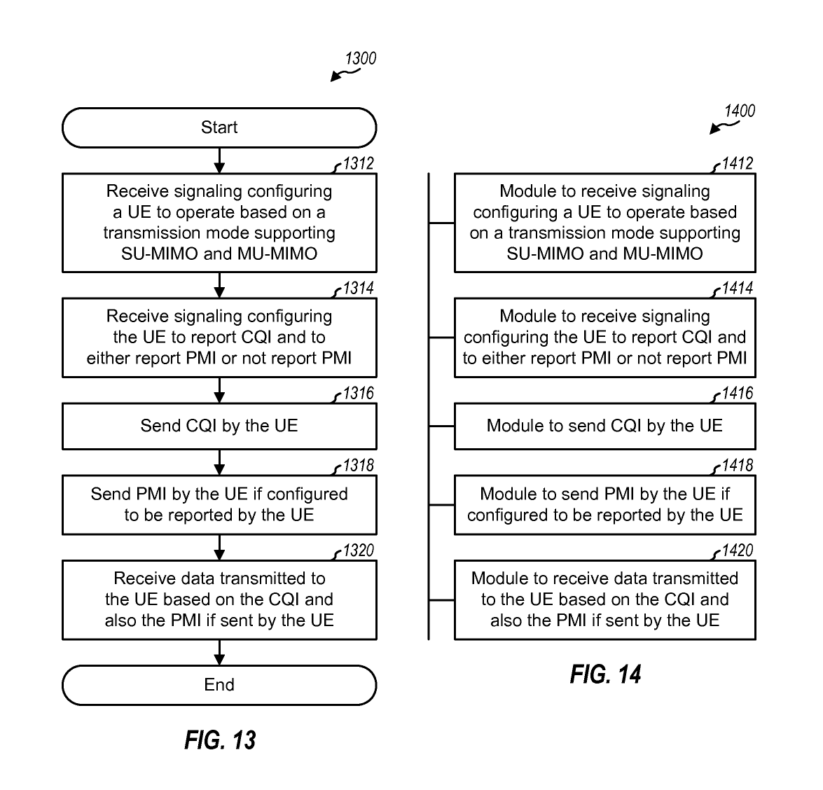

FIG. 13 shows a design of a process 1300 for reporting PMI/RI. Process 1300 may be performed by a UE (as described below) or by some other entity. The UE may receive signaling configuring the UE to operate based on a transmission mode supporting SU-MIMO and MU-MIMO (block 1312). The UE may receive signaling configuring the UE to report CQI and to either report PMI or not report PMI (block 1314). The UE may receive the signaling via Layer 3 to semi-statically configure the UE. The UE may send CQI (block 1316) and may also send PMI if it is configured to be reported by the UE (block 1318). The UE may receive data transmitted to the UE based on the CQI and also the PMI if sent by the UE (block 1320).

In one design, the UE may receive data precoded based on a precoding vector or matrix indicated by the PMI, if sent by the UE. In one design, the UE may receive data transmitted with transmit diversity if PMI is not sent by the UE.

In one design, the UE may receive signaling configuring the UE to either report RI or not report RI. The UE may send RI if it is configured to be reported by the UE. The UE may receive data transmitted to the UE based further on the RI, if sent by the UE. The UE may receive data transmitted based on a rank of one if the UE is configured to not report RI.

FIG. 14 shows a design of an apparatus 1400 for reporting PMI/RI. Apparatus 1400 includes a module 1412 to receive signaling configuring a UE to operate based on a transmission mode supporting SU-MIMO and MU-MIMO, a module 1414 to receive signaling configuring the UE to report CQI and to either report PMI or not report PMI, a module 1416 to send CQI by the UE, a module 1418 to send PMI by the UE if configured to be reported by the UE, and a module 1420 to receive data transmitted to the UE based on the CQI and also the PMI if sent by the UE.

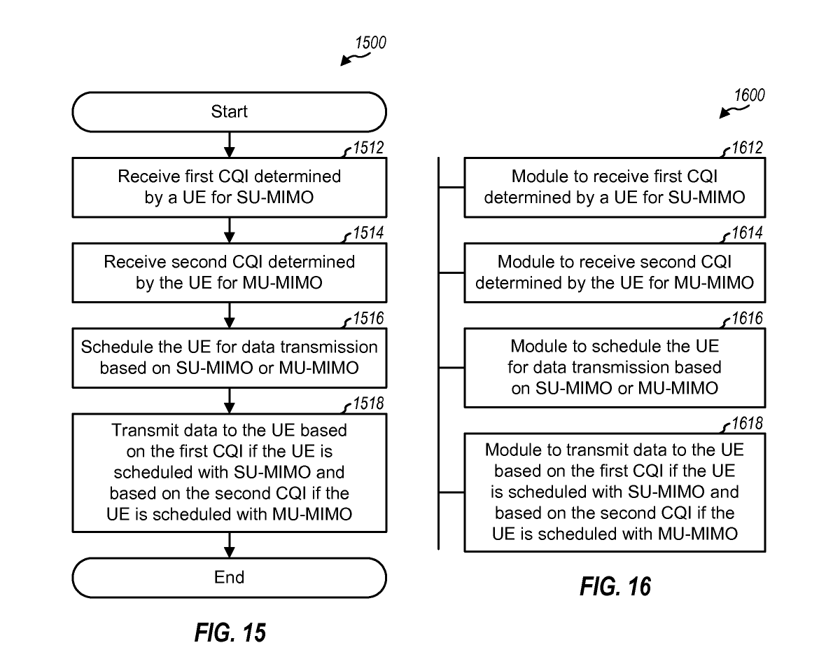

FIG. 15 shows a design of a process 1500 for receiving CQI. Process 1500 may be performed by a network (e.g., a base station/eNB and/or some other network entity). First CQI determined by a UE for SU-MIMO may be received (block 1512). Second CQI determined by the UE for MU-MIMO may also be received (block 1514). The UE may be scheduled for data transmission based on SU-MIMO or MU-MIMO (block 1516). Data may be transmitted to the UE based on the first CQI if the UE is scheduled with SU-MIMO and based on the second CQI if the UE is scheduled with MU-MIMO (block 1518).

In one design, the first CQI for SU-MIMO may comprise M absolute CQI values for rank M, where M may be one or greater. In another design, the first CQI may comprise (i) one absolute CQI value for rank 1 or (ii) one absolute CQI value and one differential CQI value for rank 2.

In one design, the second CQI for MU-MIMO may comprise M absolute CQI values for rank M, where M may be one or greater. In another design, the second CQI may comprise (i) one absolute CQI value for rank 1 or (ii) one absolute CQI value and one differential CQI value for rank 2. In yet another design, the second CQI may comprise (i) one differential CQI value for rank 1 or (ii) two differential CQI values for rank 2. In this design, each differential CQI value may be determined based on the first CQI as a reference.

In one design, a report comprising the first CQI and the second CQI may be received from the UE. In another design, a first report comprising the first CQI may be received, and a second report comprising the second CQI may also be received. The first and second reports may be sent by the UE with TDM or in some other manner.

FIG. 16 shows a design of an apparatus 1600 for receiving CQI. Apparatus 1600 includes a module 1612 to receive first CQI determined by a UE for SU-MIMO, a module 1614 to receive second CQI determined by the UE for MU-MIMO, a module 1616 to schedule the UE for data transmission with SU-MIMO or MU-MIMO, and a module 1618 to transmit data to the UE based on the first CQI if the UE is scheduled with SU-MIMO and based on the second CQI if the UE is scheduled with MU-MIMO.

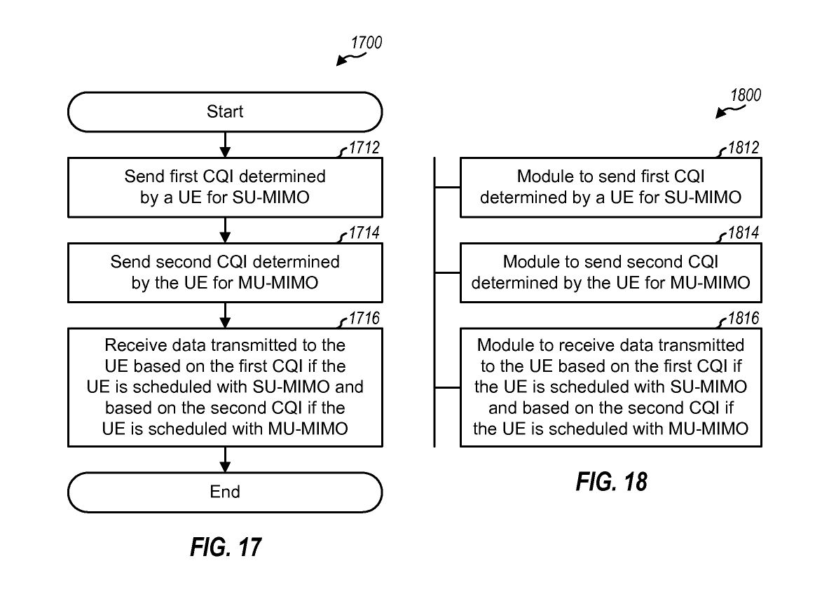

FIG. 17 shows a design of a process 1700 for reporting CQI. Process 1700 may be performed by a UE (as described below) or by some other entity. The UE may send first CQI determined by the UE for SU-MIMO (block 1712). The UE may send second CQI determined by the UE for MU-MIMO (block 1714). The UE may receive data transmitted to the UE based on the first CQI if the UE is scheduled with SU-MIMO and based on the second CQI if the UE is scheduled with MU-MIMO (block 1716).

In one design, the UE may generate the first CQI for SU-MIMO comprising M absolute CQI values for rank M, where M is one or greater. In another design, the UE may generate the first CQI comprising (i) one absolute CQI value for rank 1 or (ii) one absolute CQI value and one differential CQI value for rank 2.

In one design, the UE may generate the second CQI for MU-MIMO comprising M absolute CQI values for rank M, where M is one or greater. In another design, the UE may generate the second CQI comprising (i) one absolute CQI value for rank 1 or (ii) one absolute CQI value and one differential CQI value for rank 2. In yet another design, the UE may generate the second CQI comprising (i) one differential CQI value for rank 1 or (ii) two differential CQI values for rank 2. In this design, each differential CQI value may be determined based on the first CQI (or the SINR of the corresponding data stream with SU-MIMO) as a reference.

In one design, the UE may send a report comprising the first CQI and the second CQI. In another design, the UE may send a first report comprising the first CQI and may send a second report comprising the second CQI. The UE may send the first and second reports with TDM or in other manners.

FIG. 18 shows a design of an apparatus 1800 for reporting CQI. Apparatus 1800 includes a module 1812 to send first CQI determined by a UE for SU-MIMO, a module 1814 to send second CQI determined by the UE for MU-MIMO, and a module 1816 to receive data transmitted to the UE based on the first CQI if the UE is scheduled with SU-MIMO and based on the second CQI if the UE is scheduled with MU-MIMO.

The modules in FIGS. 4, 6, 8, 10, 12, 14, 16 and 18 may comprise processors, electronic devices, hardware devices, electronic components, logical circuits, memories, software codes, firmware codes, etc., or any combination thereof.

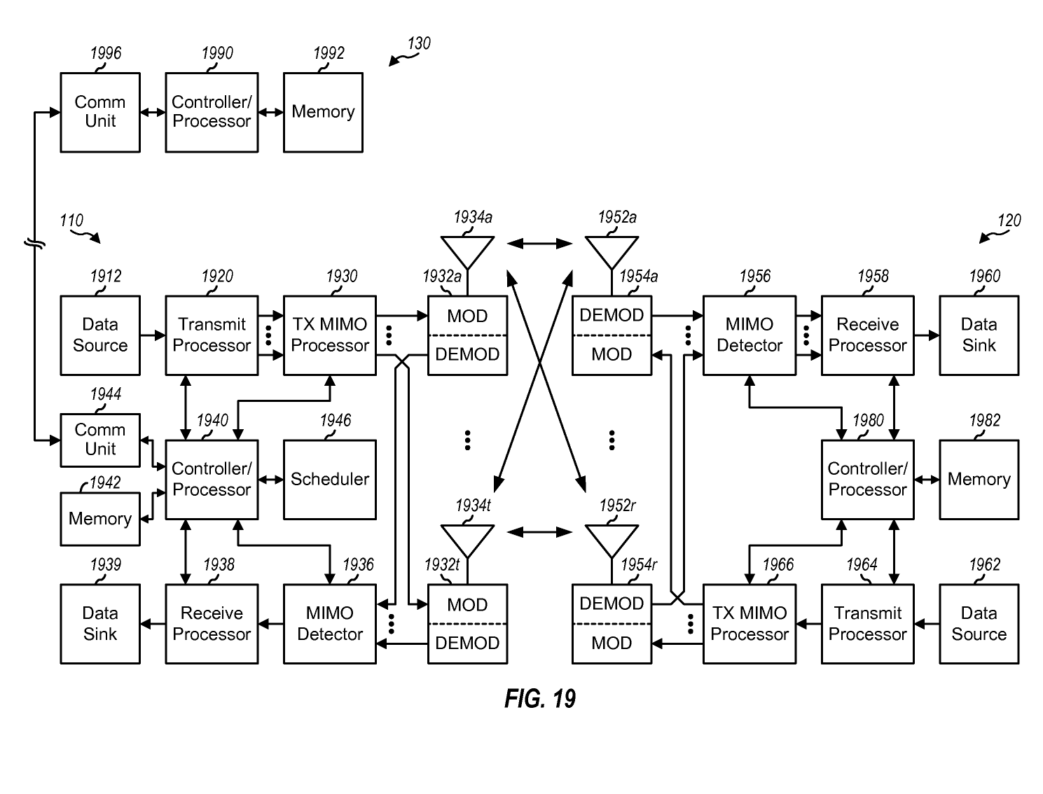

FIG. 19 shows a block diagram of a design of a base station/eNB 110 and a UE 120, which may be one of the base stations/eNBs and one of the UEs in FIG. 1. Base station 110 may be equipped with T antennas 1934a through 1934t, and UE 120 may be equipped with R antennas 1952a through 1952r, where in general T≧1 and R≧1.

At base station 110, a transmit processor 1920 may receive data from a data source 1912 for one or more UEs, process (e.g., encode and modulate) the data for each UE based on one or more modulation and coding schemes selected for that UE, and provide data symbols for all UEs. Processor 1920 may also receive control information (e.g., for Layer 2 and/or Layer 3) from a controller/processor 1940, process the control information, and provide control symbols. Processor 1920 may also generate reference symbols for synchronization signals, cell-specific reference signals, UE-RS, etc. A transmit (TX) MIMO processor 1930 may perform spatial processing (e.g., precoding) on the data symbols, the control symbols, and/or the reference symbols, if applicable, and may provide T output symbol streams to T modulators (MODs) 1932a through 1932t. Each modulator 1932 may process a respective output symbol stream (e.g., for OFDM, etc.) to obtain an output sample stream. Each modulator 1932 may further process (e.g., convert to analog, amplify, filter, and upconvert) the output sample stream to obtain a downlink signal. T downlink signals from modulators 1932a through 1932t may be transmitted via T antennas 1934a through 1934t, respectively.

At UE 120, antennas 1952a through 1952r may receive the downlink signals from base station 110 and possibly other base stations and may provide received signals to demodulators (DEMODs) 1954a through 1954r, respectively. Each demodulator 1954 may condition (e.g., filter, amplify, downconvert, and digitize) a respective received signal to obtain input samples. Each demodulator 1954 may further process the input samples (e.g., for OFDM, etc.) to obtain received symbols. A MIMO detector 1956 may obtain received symbols from all R demodulators 1954a through 1954r, perform MIMO detection on the received symbols if applicable, and provide detected symbols. A receive processor 1958 may process (e.g., demodulate and decode) the detected symbols, provide decoded data for UE 120 to a data sink 1960, and provide decoded control information for UE 120 to a controller/processor 1980.

On the uplink, at UE 120, a transmit processor 1964 may receive data from a data source 1962 and control information (e.g., for CQI, PMI, RI, etc.) from controller/processor 1980. Processor 1964 may process (e.g., encode and modulate) the data and control information to obtain data symbols and control symbols, respectively. Processor 1964 may also generate reference symbols for a reference signal. The symbols from transmit processor 1964 may be precoded by a TX MIMO processor 1966 if applicable, further processed by modulators 1954a through 1954r (e.g., for SC-FDM, OFDM, etc.), and transmitted to base station 110 and possibly other base stations. At base station 110, the uplink signals from UE 120 and other UEs may be received by antennas 1934, processed by demodulators 1932, detected by a MIMO detector 1936, and further processed by a receive processor 1938 to obtain decoded data and control information sent by UE 120 and other UEs. Processor 1938 may provide the decoded data to a data sink 1939 and the decoded control information to controller/processor 1940.

Controllers/processors 1940 and 1980 may direct the operation at base station 110 and UE 120, respectively. Processor 1940 and/or other processors and modules at base station 110 may perform or direct all or part of process 300 in FIG. 3, process 700 in FIG. 7, process 1100 in FIG. 11, process 1500 in FIG. 15, and/or other processes for the techniques described herein. Processor 1980 and/or other processors and modules at UE 120 may perform or direct all or part of process 500 in FIG. 5, process 900 in FIG. 9, process 1300 in FIG. 13, process 1700 in FIG. 17, and/or other processes for the techniques described herein. Memories 1942 and 1982 may store data and program codes or instructions for base station 110 and UE 120, respectively. A communication (Comm) unit 1944 may enable base station 110 to communicate with other network entities. A scheduler 1946 may schedule UEs for data transmission on the downlink and/or uplink.

FIG. 19 also shows a design of network controller 130 in FIG. 1. Within network controller 130, a controller/processor 1990 may perform various functions to support communication and/or other services for UEs. Controller/processor 1990 may also perform or direct all or part of process 300 in FIG. 3, process 700 in FIG. 7, process 1100 in FIG. 11, process 1500 in FIG. 15, and/or other processes for the techniques described herein. A memory 1992 may store program codes and data for network controller 130. A communication unit 1996 may enable network controller 130 to communicate with other network entities.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
scheduling a user equipment (UE) for data transmission based on a transmission mode supporting multi-user multiple-input multiple-output (MU-MIMO);
assigning an antenna port among a plurality of antenna ports to the UE;
generating a control message for the UE based on a downlink control information (DCI) format available for the transmission mode supporting MU-MIMO; and
setting a designated field of the control message to convey the antenna port assigned to the UE, the designated field conveying other information when the DCI format is used for another transmission mode not supporting MU-MIMO.

2. The method of claim 1, wherein the plurality of antenna ports comprise a first antenna port and a second antenna port, and wherein the designated field is set to a first value to indicate the first antenna port being assigned to the UE or to a second value to indicate the second antenna port being assigned to the UE.

3. The method of claim 1, wherein the designated field comprises a flag indicating an assignment of localized or distributed virtual resource blocks when the DCI format is used for the another transmission mode not supporting MU-MIMO.

4. An apparatus for wireless communication, comprising:
means for scheduling a user equipment (UE) for data transmission based on a transmission mode supporting multi-user multiple-input multiple-output (MU-MIMO);
means for assigning an antenna port among a plurality of antenna ports to the UE;
means for generating a control message for the UE based on a downlink control information (DCI) format available for the transmission mode supporting MU-MIMO; and
means for setting a designated field of the control message to convey the antenna port assigned to the UE, the designated field conveying other information when the DCI format is used for another transmission mode not supporting MU-MIMO.

5. The apparatus of claim 4, wherein the plurality of antenna ports comprise a first antenna port and a second antenna port, and wherein the designated field is set to a first value to indicate the first antenna port being assigned to the UE or to a second value to indicate the second antenna port being assigned to the UE.

6. The apparatus of claim 4, wherein the designated field comprises a flag indicating an assignment of localized or distributed virtual resource blocks when the DCI format is used for the another transmission mode not supporting MU-MIMO.

7. An apparatus for wireless communication, comprising:
at least one processor configured to schedule a user equipment (UE) for data transmission based on a transmission mode supporting multi-user multiple-input multiple-output (MU-MIMO), to assign an antenna port among a plurality of antenna ports to the UE, to generate a control message for the UE based on a downlink control information (DCI) format available for the transmission mode supporting MU-MIMO, and to set a designated field of the control message to convey the antenna port assigned to the UE, the designated field conveying other information when the DCI format is used for another transmission mode not supporting MU-MIMO.

8. A computer program product comprising a non-transitory computer-readable medium comprising instructions stored thereon, the instructions when executed cause at least one computer to:
schedule a user equipment (UE) for data transmission based on a transmission mode supporting multi-user multiple-input multiple-output (MU-MIMO);
assign an antenna port among a plurality of antenna ports to the UE;
generate a control message for the UE based on a downlink control information (DCI) format available for the transmission mode supporting MU-MIMO; and
set a designated field of the control message to convey the antenna port assigned to the UE, the designated field conveying other information when the DCI format is used for another transmission mode not supporting MU-MIMO.

9. A method for wireless communication, comprising:
receiving signaling configuring a user equipment (UE) with a transmission mode supporting multi-user multiple-input multiple-output (MU-MIMO);
receiving a control message sent to the UE and generated based on a downlink control information (DCI) format available for the transmission mode supporting MU-MIMO; and
determining an antenna port assigned to the UE, from among a plurality of antenna ports, based on a designated field of the control message, the designated field conveying other information when the DCI format is used for another transmission mode not supporting MU-MIMO.

10. The method of claim 9, wherein the plurality of antenna ports comprise a first antenna port and a second antenna port, and wherein the determining the antenna port assigned to the UE comprises:
determining that the first antenna port is assigned to the UE based on the designated field being set to a first value, and
determining that the second antenna port is assigned to the UE based on the designated field being set to a second value.

11. The method of claim 9, wherein the designated field comprises a flag indicating an assignment of localized or distributed virtual resource blocks when the DCI format is used for the another transmission mode not supporting MU-MIMO.

12. An apparatus for wireless communication, comprising:
means for receiving signaling configuring a user equipment (UE) with a transmission mode supporting multi-user multiple-input multiple-output (MU-MIMO);
means for receiving a control message sent to the UE and generated based on a downlink control information (DCI) format available for the transmission mode supporting MU-MIMO; and
means for determining an antenna port assigned to the UE, from among a plurality of antenna ports, based on a designated field of the control message, the designated field conveying other information when the DCI format is used for another transmission mode not supporting MU-MIMO.

13. The apparatus of claim 12, wherein the plurality of antenna ports comprise a first antenna port and a second antenna port, and wherein the means for determining the antenna port assigned to the UE comprises:
means for determining that the first antenna port is assigned to the UE based on the designated field being set to a first value, and
means for determining that the second antenna port is assigned to the UE based on the designated field being set to a second value.

14. The apparatus of claim 12, wherein the designated field comprises a flag indicating an assignment of localized or distributed virtual resource blocks when the DCI format is used for the another transmission mode not supporting MU-MIMO.

15. A method for wireless communication, comprising:
configuring a user equipment (UE) with a plurality of antenna port combinations corresponding to a subset of all possible antenna port combinations;
assigning an antenna port combination among the plurality of antenna port combinations to the UE for a data transmission; and
sending control information to convey the antenna port combination assigned to the UE.

16. The method of claim 15, wherein each antenna port combination is associated with at least one antenna to use for the data transmission among a plurality of available antenna ports.

17. The method of claim 15, wherein the UE is configured with the plurality of antenna port combinations via Layer 3, and wherein the control information is sent to the UE via Layer 2.

18. The method of claim 15, wherein the UE is semi-statically configured with the plurality of antenna port combinations, and wherein the UE is dynamically assigned one antenna port combination for each data transmission.

19. The method of claim 15, further comprising:
scheduling the UE for the data transmission based on a transmission mode supporting multi-user multiple-input multiple-output (MU-MIMO).

20. The method of claim 19, wherein the sending the control information comprises:
generating a control message for the UE based on a downlink control information (DCI) format available for the transmission mode supporting MU-MIMO, and
setting at least one designated field of the control message to convey the antenna port combination assigned to the UE, the at least one designated field conveying other information when the DCI format is used for another transmission mode not supporting MU-MIMO.

21. The method of claim 15, further comprising:
transmitting data via the antenna port combination assigned to the UE.

22. An apparatus for wireless communication, comprising:
means for configuring a user equipment (UE) with a plurality of antenna port combinations corresponding to a subset of all possible antenna port combinations;
means for assigning an antenna port combination among the plurality of antenna port combinations to the UE for a data transmission; and
means for sending control information to convey the antenna port combination assigned to the UE.

23. The apparatus of claim 22, wherein the UE is configured with the plurality of antenna port combinations via Layer 3, and wherein the control information is sent to the UE via Layer 2.

24. The apparatus of claim 22, wherein the UE is semi-statically configured with the plurality of antenna port combinations, and wherein the UE is dynamically assigned one antenna port combination for each data transmission.

25. A method for wireless communication, comprising:
receiving signaling configuring a user equipment (UE) with a plurality of antenna port combinations corresponding to a subset of all possible antenna port combinations; and
receiving control information assigning an antenna port combination among the plurality of antenna port combinations to the UE for a data transmission.

26. The method of claim 25, wherein the signaling configuring the UE is received via Layer 3, and wherein the control information assigning the antenna port combination to the UE is received via Layer 2.

27. The method of claim 25, wherein the UE is semi-statically configured with the plurality of antenna port combinations, and wherein the UE is dynamically assigned one antenna port combination for each data transmission.

28. The method of claim 25, wherein the UE is scheduled for the data transmission based on a transmission mode supporting multi-user multiple-input multiple-output (MU-MIMO).

29. The method of claim 28, wherein the receiving the control information comprises
receiving a control message sent to the UE and generated based on a downlink control information (DCI) format available for the transmission mode supporting MU-MIMO, and
determining the antenna port combination assigned to the UE based on at least one designated field of the control message, the at least one designated field conveying other information when the DCI format is used for another transmission mode not supporting MU-MIMO.

30. An apparatus for wireless communication, comprising:
means for receiving signaling configuring a user equipment (UE) with a plurality of antenna port combinations corresponding to a subset of all possible antenna port combinations; and
means for receiving control information assigning an antenna port combination among the plurality of antenna port combinations to the UE for a data transmission.

31. The apparatus of claim 30, wherein the signaling configuring the UE is received via Layer 3, and wherein the control information assigning the antenna port combination to the UE is received via Layer 2.

32. The apparatus of claim 30, wherein the UE is semi-statically configured with the plurality of antenna port combinations, and wherein the UE is dynamically assigned one antenna port combination for each data transmission.

33. A method for wireless communication, comprising:
configuring a user equipment (UE) to operate based on a transmission mode supporting single-user multiple-input multiple-output (SU-MIMO) and multi-user MIMO (MU-MIMO);
configuring the UE to report channel quality indicator (CQI) and to either report precoding matrix indicator (PMI) or not report PMI;
receiving CQI from the UE;
receiving PMI from the UE if configured to be reported by the UE; and
transmitting data to the UE based on the CQI and also the PMI if received from the UE.

34. The method of claim 33, further comprising:
configuring the UE to either report rank indicator (RI) or not report RI;
receiving RI from the UE if configured to be reported by the UE; and
transmitting data to the UE based further on the RI if received from the UE.

35. The method of claim 34, wherein the transmitting data comprises transmitting data based on a rank of one if the UE is configured to not report RI.

36. The method of claim 33, wherein the transmitting data comprises precoding data based on a precoding vector or matrix indicated by the PMI if received from the UE.

37. The method of claim 33, wherein the transmitting data comprises transmitting data with transmit diversity if the PMI is not received from the UE.

38. The method of claim 33, wherein the UE is semi-statically configured to report PMI or not report PMI via Layer 3.

39. An apparatus for wireless communication, comprising:
means for configuring a user equipment (UE) to operate based on a transmission mode supporting single-user multiple-input multiple-output (SU-MIMO) and multi-user MIMO (MU-MIMO);
means for configuring the UE to report channel quality indicator (CQI) and to either report precoding matrix indicator (PMI) or not report PMI;
means for receiving CQI from the UE;
means for receiving PMI from the UE if configured to be reported by the UE; and
means for transmitting data to the UE based on the CQI and also the PMI if received from the UE.

40. The apparatus of claim 39, further comprising:
means for configuring the UE to either report rank indicator (RI) or not report RI;
means for receiving RI from the UE if configured to be reported by the UE; and
means for transmitting data to the UE based further on the RI if received from the UE.

41. A method for wireless communication, comprising:
receiving signaling configuring a user equipment (UE) to operate based on a transmission mode supporting single-user multiple-input multiple-output (SU-MIMO) and multi-user MIMO (MU-MIMO);
receiving signaling configuring the UE to report channel quality indicator (CQI) and to either report precoding matrix indicator (PMI) or not report PMI;
sending CQI by the UE;
sending PMI by the UE if configured to be reported by the UE; and
receiving data transmitted to the UE based on the CQI and also the PMI if sent by the UE.

42. The method of claim 41, further comprising:
receiving signaling configuring the UE to either report rank indicator (RI) or not report RI;
sending RI by the UE if configured to be reported by the UE; and
receiving data transmitted to the UE based further on the RI if sent by the UE.

43. The method of claim 42, wherein the receiving data comprises receiving data transmitted based on a rank of one if the UE is configured to not report RI.

44. The method of claim 41, wherein the receiving data comprises receiving data precoded based on a precoding vector or matrix indicated by the PMI if sent by the UE.

45. The method of claim 41, wherein the receiving data comprises receiving data transmitted with transmit diversity if the PMI is not sent by the UE.

46. The method of claim 41, wherein the UE is semi-statically configured to report PMI or not report PMI via Layer 3.

47. An apparatus for wireless communication, comprising:
means for receiving signaling configuring a user equipment (UE) to operate based on a transmission mode supporting single-user multiple-input multiple-output (SU-MIMO) and multi-user MIMO (MU-MIMO);
means for receiving signaling configuring the UE to report channel quality indicator (CQI) and to either report precoding matrix indicator (PMI) or not report PMI;
means for sending CQI by the UE;
means for sending PMI by the UE if configured to be reported by the UE; and
means for receiving data transmitted to the UE based on the CQI and also the PMI if sent by the UE.

48. The apparatus of claim 47, further comprising:
means for receiving signaling configuring the UE to either report rank indicator (RI) or not report RI;
means for sending RI by the UE if configured to be reported by the UE; and
means for receiving data transmitted to the UE based further on the RI if sent by the UE.

49. A method for wireless communication, comprising:
receiving first channel quality indicator (CQI) determined by a user equipment (UE) for single-user multiple-input multiple-output (SU-MIMO);
receiving second CQI determined by the UE for multi-user MIMO (MU-MIMO);
scheduling the UE for data transmission based on SU-MIMO or MU-MIMO; and
transmitting data to the UE based on the first CQI if the UE is scheduled with SU-MIMO and based on the second CQI if the UE is scheduled with MU-MIMO.

50. The method of claim 49, wherein the first CQI comprises one absolute CQI value for rank 1, or one absolute CQI value and one differential CQI value for rank 2.

51. The method of claim 49, wherein the second CQI comprises one absolute CQI value for rank 1, or one absolute CQI value and one differential CQI value for rank 2.

52. The method of claim 49, wherein the second CQI comprises one differential CQI value for rank 1 or two differential CQI values for rank 2, and wherein each differential CQI value is determined based on the first CQI as a reference.

53. The method of claim 49, further comprising:
receiving a report comprising the first CQI and the second CQI.

54. The method of claim 49, further comprising:
receiving a first report comprising the first CQI; and
receiving a second report comprising the second CQI.

55. The method of claim 54, wherein the first and second reports are sent by the UE with time division multiplexing (TDM).

56. An apparatus for wireless communication, comprising:
means for receiving first channel quality indicator (CQI) determined by a user equipment (UE) for single-user multiple-input multiple-output (SU-MIMO);
means for receiving second CQI determined by the UE for multi-user MIMO (MU-MIMO);
means for scheduling the UE for data transmission based on SU-MIMO or MU-MIMO; and
means for transmitting data to the UE based on the first CQI if the UE is scheduled with SU-MIMO and based on the second CQI if the UE is scheduled with MU-MIMO.

57. The apparatus of claim 56, wherein the first CQI comprises one absolute CQI value for rank 1, or one absolute CQI value and one differential CQI value for rank 2.

58. The apparatus of claim 56, wherein the second CQI comprises one differential CQI value for rank 1 or two differential CQI values for rank 2, and wherein each differential CQI value is determined based on the first CQI as a reference.

59. A method for wireless communication, comprising:
sending first channel quality indicator (CQI) determined by a user equipment (UE) for single-user multiple-input multiple-output (SU-MIMO);
sending second CQI determined by the UE for multi-user MIMO (MU-MIMO); and
receiving data transmitted to the UE based on the first CQI if the UE is scheduled with SU-MIMO and based on the second CQI if the UE is scheduled with MU-MIMO.

60. The method of claim 59, further comprising:
generating the first CQI comprising one absolute CQI value for rank 1, or one absolute CQI value and one differential CQI value for rank 2.

61. The method of claim 59, further comprising:
generating the second CQI comprising one absolute CQI value for rank 1, or one absolute CQI value and one differential CQI value for rank 2.

62. The method of claim 59, further comprising:
generating the second CQI comprising one differential CQI value for rank 1 or two differential CQI values for rank 2, wherein each differential CQI value is determined based on the first CQI as a reference.

63. The method of claim 59, further comprising:
sending a report comprising the first CQI and the second CQI.

64. The method of claim 59, further comprising:
sending a first report comprising the first CQI; and
sending a second report comprising the second CQI.

65. The method of claim 64, wherein the first and second reports are sent by the UE with time division multiplexing (TDM).

66. An apparatus for wireless communication, comprising:
means for sending first channel quality indicator (CQI) determined by a user equipment (UE) for single-user multiple-input multiple-output (SU-MIMO);
means for sending second CQI determined by the UE for multi-user MIMO (MU-MIMO); and
means for receiving data transmitted to the UE based on the first CQI if the UE is scheduled with SU-MIMO and based on the second CQI if the UE is scheduled with MU-MIMO.

67. The apparatus of claim 66, further comprising:
means for generating the first CQI comprising one absolute CQI value for rank 1, or one absolute CQI value and one differential CQI value for rank 2.

68. The apparatus of claim 66, further comprising:
means for generating the second CQI comprising one differential CQI value for rank 1 or two differential CQI values for rank 2, wherein each differential CQI value is determined based on the first CQI as a reference.
